(19) United States
(12) Patent Application Publication
(10) Pub. No.: US 2026/0238915 A1
(43) Pub. Date: Aug. 13, 2026

(54) CLIP-ON EARPHONE

(71) Applicant: Guangdong Genius Technology Co., LTD., Dongguan, Guangdong (CN)

(72) Inventors: Zilu Wang, Dongguan, Guangdong (CN); Zhijian Li, Dongguan, Guangdong (CN); Lei Qi, Dongguan, Guangdong (CN); Liang Cheng, Dongguan, Guangdong (CN); Huanfeng Lv, Dongguan, Guangdong (CN); Guanjie Qian, Dongguan, Guangdong (CN)

(73) Assignee: Guangdong Genius Technology Co., LTD., Dongguan, Guangdong (CN)

(21) Appl. No.: 19/155,987

(22) PCT Filed: May 9, 2024
(86) PCT No.: PCT/CN2024/091981

§ 371 Date: Aug. 13, 2025

(30) Foreign Application Priority Data
May 24, 2023 (CN) 202310591148.6

(51) Int. Cl. H04R 1/10; H04R 1/1025

(52) U.S. Cl. CPC H04R 1/105; H04R 1/1016; H04R 1/1025; H04R 1/1066

(57) ABSTRACT

The present application discloses a clip-on earphone comprising: an earphone body having a first accommodating cavity, installed with a battery and a speaker; a clamping assembly comprising a first and a second clamping arm and an adjusting member. The first end of the first clamping arm is connected to the earphone body, and the second end to the second clamping arm via the adjusting member which adjusts a pivot angle between the first and second clamping arms to wear the earphone body onto an ear. The angle between the clamping assembly and the earphone body can be freely adjusted. Consumers can find a suitable wearing angle according to their own body and auricle shape, improving wearing experience and reducing pain caused by wearing earphones. By properly arranging earphone components, weight is concentrated on the earphone head to reduce pressure on ear side wall and improve wearing comfort.

### FIELD OF THE DISCLOSURE

The present application relates to a technical field of electronic products, and further to a clip-on earphone.

### BACKGROUND

In recent years, with a continuous improvement of living standards, various electronic products have successively entered our daily life and become an indispensable part of our work, study and leisure activities. Among them, earphones are a particularly important type of electronic product. Earphones are conversion units that convert electrical signals received from a media player into sound waves audible to human ears via speakers. Earphones are increasingly popular among consumers due to their high portability and small size. At the same time, consumer demand for earphones is getting higher, and consumer expectations and requirements for earphones are also constantly increasing.

Currently, TWS (True Wireless Stereo) earphones on the market come in various types: head-mounted, in-ear, semi-in-ear, clip-on, etc., but each form has its own drawbacks. Head-mounted types are bulky and not easily portable; in-ear and semi-in-ear types often lack a secure fit and can feel intrusive; clip-on types, typically made of hard or soft plastic, are inconvenient to wear and often do not conform well to the shape of the ear, leading to discomfort.

### SUMMARY OF THE INVENTION

In view of the above technical problems, the purpose of the present application is to provide a clip-on earphone, in which an angle between the clamping component and the earphone body can be freely adjusted, and consumers can find a suitable wearing angle according to their own body shape and auricle shape, thereby improving consumer wearing experience and reducing pain caused by wearing earphones. At the same time, by properly arranging the earphone components, weight is concentrated on the earphone head to reduce the pressure on the side wall of the ear, thereby further improving wearing comfort.

In order to achieve the above objects, the present application provides a clip-on earphone, comprising:
an earphone body having a first accommodating cavity, wherein a battery and a speaker are installed in the first accommodating cavity; and
a clamping assembly comprising a first clamping arm, a second clamping arm and an adjusting member, wherein a first end of the first clamping arm is connected to the earphone body, and a second end of the first clamping arm is connected to the second clamping arm through the adjusting member, and the adjusting member is adapted to adjust a pivot angle between the first clamping arm and the second clamping arm so that the earphone body can be worn onto a human ear.

In the present technical solution, the angle between the clamping component and the earphone body can be freely adjusted, and consumers can find a suitable wearing angle according to their own body shape and auricle shape, thereby achieving the purpose of improving consumer wearing experience and reducing pain caused by wearing earphones. At the same time, by properly arranging the earphone components, the two heavier components, the battery and the speaker, are provided on the earphone head, so that the weight is concentrated on the earphone head. Upon wearing, the earphone head is placed inside the concha cavity, and the side of the concha cavity supports the earphone head, which disperses the weight of the earphone head to the greatest extent, and the single-point pressure is small, so there will be no sense of oppression during use. The clamping component is outside the ear in a wearing state, and its light weight can reduce the pressure on the side wall of the ear, further improving wearing comfort. At the same time, this configuration with a heavy head and a light clamp can also improve the stability of the earphone.

In some embodiments, the first clamping arm has a second accommodating cavity, wherein the second accommodating cavity is interconnected to the first accommodating cavity, and a circuit board and an accessary component are installed in the second accommodating cavity.

In this technical solution, the circuit board and other lighter accessory components are arranged in the first clamping arm, which can effectively utilize the clamping arm, make the weight distribution of the earphone more reasonable, and improve the stability and comfort of wearing the earphone.

In some embodiments, the first clamping arm comprises a first connecting section and a second connecting section fixedly connected at a preset angle, wherein an end of the first connecting section away from the second connecting section is in a fix connection to the earphone body at a preset angle, and an end of the second connecting section away from the first connecting section is connected to the second clamping arm via the adjusting member.

In some embodiments, an end of the earphone body is at a preset length from a place of the fix connection between the first connecting section and the earphone body to form an ear hook portion having the preset length, and the ear hook portion is adapted to hook onto a side wall of a concha cavity, and the preset length is not less than 3 mm.

In some embodiments, the second connecting section is arranged parallel to the earphone body, and a distance between the second connecting section and the earphone body is 4 mm-7 mm; and a length of the second connecting section is 8 mm-13 mm; and an end of the second connecting section close to the first connecting section is flush with the end of the earphone body.

In some embodiments, the earphone body, the first connecting section, and the second connecting section are integrally formed into a housing, and the housing comprises a bottom shell and an upper cover, and the bottom shell and the upper cover are detachably connected.

In some embodiments, the pivot angle between the first clamping arm and the second clamping arm has a range of 60°-180°; and when the pivot angle between the first clamping arm and the second clamping arm is 60°, a distance between an end of the second clamping arm away from the first clamping arm and an end of the earphone body is no more than 3 mm.

In some embodiments, the second clamping arm is provided with a soft pad and a clearance groove, wherein the soft pad is provided at the end of the second clamping arm away from the first clamping arm, and the clearance groove is an arc-shaped groove, and the clearance groove is provided between the first clamping arm and the soft pad; and when the pivot angle between the first clamping arm and the second clamping arm is 60°, the soft pad faces the end of the earphone body.

In this technical solution, the structure of the clamping assembly is configured to take into account different wearers and ensure both wearing comfort and aesthetics.

In some embodiments, the adjusting member comprises a coil spring and a pin shaft, wherein the pin shaft is inserted into the coil spring and both ends of the pin shaft extend out of the coil spring; and an end of the first clamping arm is provided with a boss, wherein the boss is provided with a coil spring cavity, and the second clamping arm is provided with a groove, and groove walls on both sides of the groove are provided with pin shaft holes, and the boss is adapted to be inserted into the groove, and the coil spring is adapted to be installed in the coil spring cavity, and both ends of the pin shaft are respectively inserted in the corresponding pin shaft holes, so as to realize an arbitrary positioning of the pivot angle between the first clamping arm and the second clamping arm; or a boss is provided at an end of the second clamping arm, wherein the boss is provided with a coil spring cavity, and a groove is provided on the first clamping arm, and pin shaft holes are provided on groove walls on both sides of the groove, and the boss is adapted to be inserted into the groove, and the coil spring is adapted to be installed in the coil spring cavity, and two ends of the pin shaft are respectively inserted into the corresponding pin shaft holes, so as to realize arbitrary positioning of the pivot angle between the first clamping arm and the second clamping arm.

In this technical solution, a scroll structure allows the angle between the earphone body and the clamping assembly to be adjusted and fixed as needed, ensuring a secure fit that prevents the earphones from falling off during use. It also enhances ease of use and provides a comfortable user experience.

In some embodiments, the earphone body is also provided with a sound outlet, which is arranged on a side of the earphone body away from the clamping assembly, and the sound outlet is at a preset distance from an end of the earphone body, so that when the earphone body is worn onto a human ear, the sound outlet faces an ear canal.

In this technical solution, by adjusting the position of the clamping component on the auricle, the earphone body can be set above the human concha. The earphone body does not block the ear canal, which can reduce the possibility of damage to the patient's eardrum and provide greater comfort. Once put on, the sound outlet is facing the ear canal, and the sound quality is optimal.

Compared with the prior art, the clip-on earphone provided by the present application has the following beneficial effects:
1. The clip-on earphones provided by the present application have an angle between the clamping component and the earphone body that can be freely adjusted. Consumers can find a suitable wearing angle according to their own body shape and auricle shape, thereby improving consumer wearing experience and reducing pain caused by wearing earphones. At the same time, by properly arranging the earphone components, the battery and the speaker, two heavier components, are provided at the earphone head, so that the weight is concentrated on the earphone head. Upon wearing, the earphone head is placed inside the concha cavity, and the side of the concha cavity supports the earphone head, which can disperse the weight of the earphone head to the greatest extent, and localized pressure is minimized, so there will be no sense of oppression during use. The clamping component is outside the ear during use, and the light weight can reduce the pressure on the side wall of the ear, further improving wearing comfort. At the same time, such a configuration with a heavy head and a light clamp can also improve the stability of the earphone.
2. The clip-on earphones provided by the present application take into account different wearers by configuring the structure of the clamping component, achieving both wearing comfort and aesthetics. By providing a scroll structure, the opening and closing angle between the earphone body and the clamping component can be positioned as needed, and the earphones are not easy to fall off when worn by consumers, and are convenient to use and provide a comfortable experience.

### BRIEF DESCRIPTION OF THE DRAWINGS

The preferred embodiments will be described below in a clear and understandable manner with reference to the accompanying drawings to further illustrate the above-mentioned characteristics, technical features, advantages and implementation methods of the present application.

FIG. 1 is a schematic structural diagram of a clip-on earphone according to a preferred embodiment of the present application;

FIG. 2 is a cross-sectional view of a clip-on earphone according to a preferred embodiment of the present application;

FIG. 3 is a schematic structural diagram of a housing according to a preferred embodiment of the present application;

FIG. 4 is a schematic structural diagram of a bottom shell of a preferred embodiment of the present application;

FIG. 5 is a schematic structural diagram of a second clamping arm in a preferred embodiment of the present application;

FIG. 6 is a schematic structural diagram of a first arm body according to a preferred embodiment of the present application;

FIG. 7 is a cross-sectional view of a second clamping arm of a preferred embodiment of the present application;

FIG. 8 is a schematic structural diagram of a clip-on earphone in a wearing state according to a preferred embodiment of the present application.

### DESCRIPTION OF REFERENCE NUMBERS

Earphone body 1, first accommodating cavity 11, battery 111, speaker 112, ear hook portion 12, bottom shell 13, upper cover 14, sound outlet 15, clamping assembly 2, first clamping arm 21, second accommodating cavity 211, circuit board 2111, accessory component 2112, first connecting section 212, second connecting section 213, boss 214, coil spring cavity 2141, second clamping arm 22, soft pad 221, clearance groove 222, groove 223, first arm body 224, fixing column 2241, fixing hole 2242, ridge 2243, second arm body 225, adjusting member 23, coil spring 231, pin shaft 232, end cap 233.

### DESCRIPTION OF THE ILLUSTRATED EMBODIMENTS

In order to more clearly illustrate the embodiments of the present application or the technical solutions in the prior art, the specific embodiments of the present application will be described below with reference to the accompanying drawings. Obviously, the accompanying drawings in the following description are only some embodiments of the present application, and for those of ordinary skill in the art, other drawings can also be obtained from these drawings without creative efforts, to obtain other embodiments.

In order to keep the drawings concise, only the parts related to the application are schematically shown in each figure, and they do not represent the actual structure of the products. In addition, in order to make the drawings concise and easy to understand, in some figures, only one of the components having the same structure or function is schematically shown, or only one of them is marked. As used herein, “one” not only means “only one”, but also “more than one”.

It should also be further understood that, as used in this specification and the claims, the term “and/or” refers to and including any and all possible combinations of one or more of the associated listed items.

In this description, it should be noted that, unless otherwise expressly specified and limited, the terms “installed”, “connected” and “connecting” should be understood in a broad sense. For example, it may be a fixed connection or a detachable connection, or it can be connected into a whole piece; or it can be a mechanical connection or an electrical connection; or it can be directly connected or indirectly connected through an intermediate medium, and it can be internal communication between two components. For those of ordinary skill in the art, the specific meanings of the above terms in the present application can be understood in specific situations.

In addition, in the description of the present application, the terms “first”, “second” and the like are only used to distinguish the features, and should not be understood as indicating or implying relative importance.

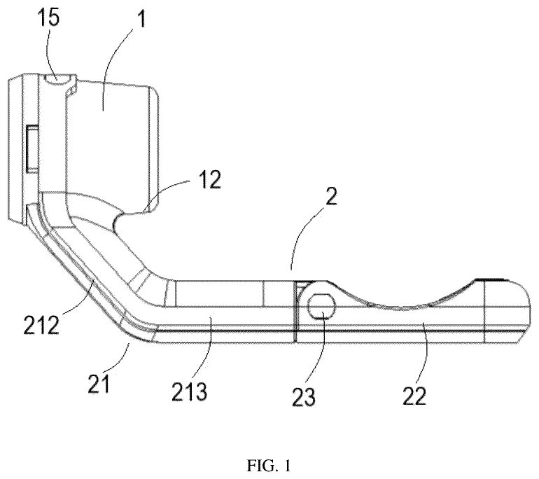

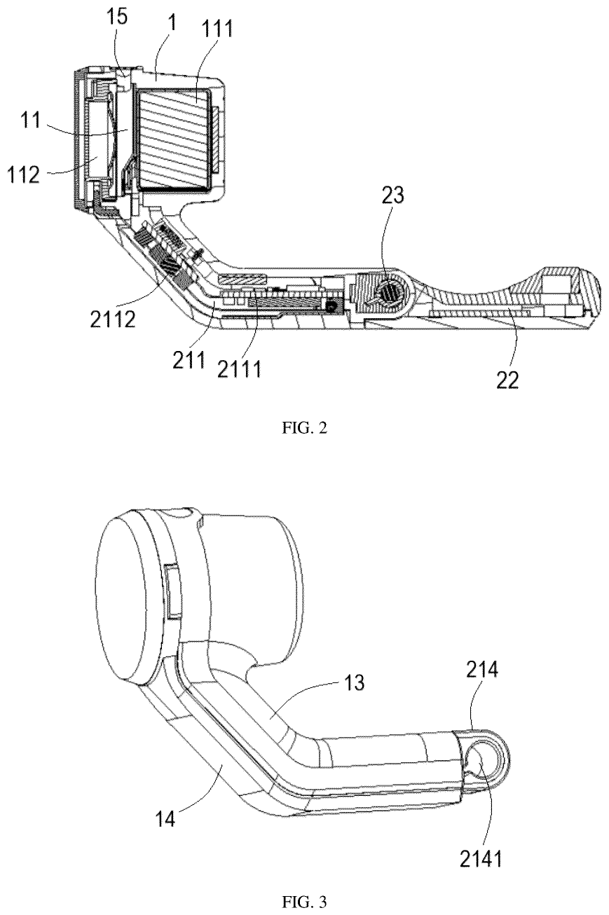

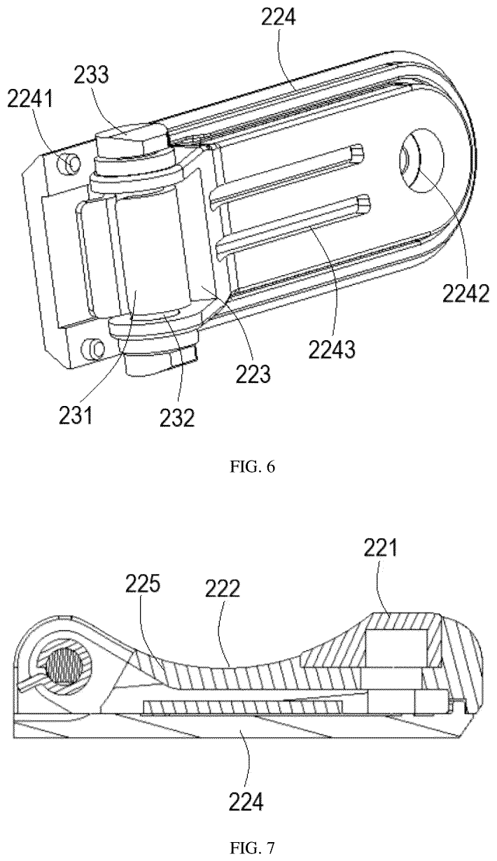

In one embodiment, with reference to FIGS. 1 to 8 of the specification, a clip-on earphone provided by the present application comprises: an earphone body 1 and a clamping assembly 2, wherein the earphone body 1 has a first accommodating cavity 11, and a battery 111 and a speaker 112 are installed in the first accommodating cavity 11. The clamping assembly 2 comprises a first clamping arm 21, a second clamping arm 22 and an adjusting member 23, wherein a first end of the first clamping arm 21 is connected to the earphone body 1, and a second end of the first clamping arm 21 is connected to the second clamping arm 22 through the adjusting member 23, and the adjusting member 23 is adapted to adjust the pivot angle between the first clamping arm 21 and the second clamping arm 22, so as to wear the earphone body 1 onto a human ear.

In actual use, the weight distribution of the earphones will directly affect their wearing experience. Unreasonable weight distribution will cause stability problems and comfort problems of the earphones. By placing the two heavier components, the battery 111 and the speaker 112, at the earphone head, the weight is concentrated to the earphone head, and the clamping assembly 2 is as simple and light as possible. Once put on, the earphone head is placed inside the concha cavity, and the side of the concha cavity supports the earphone head, which can disperse the weight of the earphone head to the greatest extent. Localized pressure is minimized, and there will be no sensation of oppression during use. The clamping assembly 2 is located outside the ear in a wearing state, and its light weight can reduce the pressure on the side wall of the ear, further improving wearing comfort. At the same time, this configuration with a heavy head and a light clamp can also improve the stability of the earphones.

In addition, the wearer can clamp his or her auricle via the clamping assembly 2 to wear the clip-on earphone onto an ear, which is well-suited for work, study, sports and other scenarios. It is comfortable to wear and has a wide range of applications. Consumers can adjust the opening and closing angle between the first clamping arm 21 and the second clamping arm 22 via the adjusting member 23 according to the shape of their own auricle, so that the clamping space comes to a proper size. Compared with existing earphones on the market, the clip-on earphone can reduce discomfort during wear, improve wearing experience and consumer enthusiasm, and meet usage needs of different user groups.

Furthermore, the first clamping arm 21 has a second accommodating cavity 211, which is interconnected to the first accommodating cavity 11. A circuit board 2111 and an accessory component 2112 are installed in the second accommodating cavity 211. The accessory component 2112 may be a magnet or other components. The circuit board 211 may be a flexible circuit board to adapt to the internal space of the second accommodating cavity 211. The hollow structure of the first clamping arm 21 can achieve weight reduction. The circuit board 2111 and other lighter accessory components 2112 are arranged in the first clamping arm 21, and the internal space of the first clamping arm 21 can be effectively utilized, so that the weight distribution of the earphone is more reasonable, and the stability and comfort of wearing the earphone are improved.

In one embodiment, referring to FIGS. 1 to 4 of the specification, the first clamping arm 21 comprises a first connecting section 212 and a second connecting section 213 fixedly connected at a preset angle, wherein the end of the first connecting section 212 away from the second connecting section 213 is in fix connection to the earphone body 1 at a preset angle, and the end of the second connecting section 213 away from the first connecting section 212 is connected to the second clamping arm 22 through the adjusting member 23. When the pivot angle between the first clamping arm 21 and the second clamping arm 22 is at its smallest value, the end of the second clamping arm 22 away from the first clamping arm 21 is spaced from the end of the earphone body 1 by a preset distance, and the distance is the thickness of the concha cavity wall. For clip-on earphones, the clamping space directly affects the compatibility of the earphones with the wearer and the wearing comfort. Through a survey of the Chinese adult population, the clamping space is specifically configured, to be compatible with about 90% of the adult population and to make the earphone comfortable to wear.

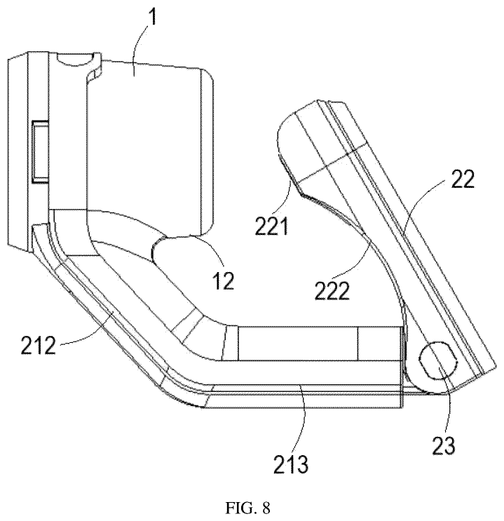

Specifically, referring to FIG. 8 of the specification, the end of the earphone body 1 is at a preset length from the fix connection between the first connecting section 212 and the earphone body 1 to form an ear hook portion 12 having the preset length, and the ear hook portion 12 is configured to hook onto the side wall of the concha cavity, and the preset length is not less than 3 mm. For example: 3 mm, 3.1 mm, 3.2 mm, 3.3 mm, 3.4 mm, 3.5 mm, 3.6 mm, 3.7 mm, 3.8 mm, 3.9 mm, 4 mm, 4.5 mm, 5 mm, etc. The ear hook portion 12 represents an inverted posture of the sidewall of the concha cavity, where the earphone can hook onto the sidewall of the concha cavity. According to research and wearing experience, by setting the preset length of the ear hook portion 12 to be not less than 3 mm, a sufficient hooking depth can be ensured between the earphone and the side wall of the concha cavity, and the wearing is more stable.

Referring to FIG. 8 of the specification, the second connecting section 213 and the earphone body 1, which are spaced apart with a distance, and the length of the second connecting section 213 constitute an accommodation space for the ear tissue at the earphone clamping position, and the two dimensions will interact with each other. The accommodation space directly affects whether the earphone will be tight once put on. Preferably, the second connecting section 213 is arranged parallel to the earphone body 1, and the distance between the second connecting section 213 and the earphone body 1 is 4 mm-7 mm. The length of the second connecting section 213 is 8 mm-13 mm. The end of the second connecting section 213 close to the first connecting section 212 is flush with the end of the earphone body 1.

Referring to FIG. 8 of the specification, the pivot angle between the first clamping arm 21 and the second clamping arm 22 has a range of 60°-180°. When the pivot angle between the first clamping arm 21 and the second clamping arm 22 is 60°, the distance between the end of the second clamping arm 22 away from the first clamping arm 21 and the end of the earphone body 1 is no more than 3 mm. This distance corresponds to the tissue thickness at the concha cavity. If it is too large, the wearing stability of the earphone will be negatively affected. And because the adjusting member can hold at any position, it can always maintain a certain clamping force, which makes the earphone compatible with those having slightly thick ears.

In this embodiment, after the earphone body 1 is placed in the concha cavity, the ear hook portion 12 is hooked onto the side wall of the concha cavity, so that the first clamping arm 21 covers the antitragus 02, and the second clamping arm 22 is clamped onto the helix to complete clip-on fixation. The earphone is fixed onto the ear by the joint action of the earphone body 1 and the clamping assembly 2, which can improve the fixing strength of in-ear earphones, semi-in-ear earphones, and open earphones, thereby preventing the earphones from falling off. In addition, the earphone body 1 and the clamping assembly 2 comprise hard skeleton structures, which make wearing more stable and secure. Soft pads can be provided at the parts in contact with the skin to improve wearing comfort. By configuring the structure of the clamping assembly 2, different wearers can be taken into account and both wearing comfort and aesthetics can be achieved.

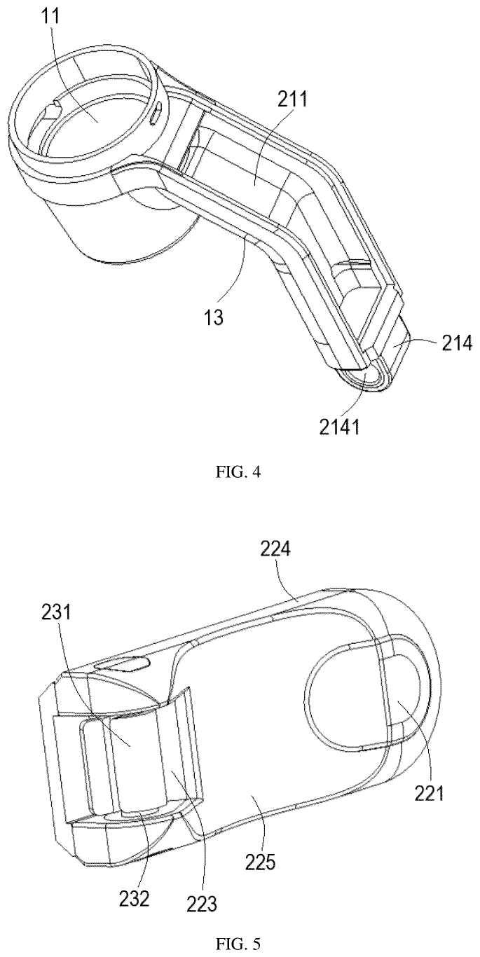

In one embodiment, referring to FIGS. 3 and 4 of the specification, the earphone body 1, the first connecting section 212, and the second connecting section 213 are integrally formed to constitute a housing, and the housing comprises a bottom shell 13 and an upper cover 14, and the bottom shell 13 and the upper cover 14 are detachably connected, which facilitates the installation of components such as the circuit board 2111. The bottom shell 13 and the upper cover 14 can be connected by snapping or screws. The peripheral sides of the earphone body 1, the first connecting section 212, and the second connecting section 213 are all smooth surfaces.

Referring to FIGS. 5 to 7 of the specification, the second clamping arm 22 is provided with a soft pad 221 and a clearance groove 222. The soft pad 221 is provided at the end of the second clamping arm 22 away from the first clamping arm 21. The clearance groove 222 is an arc-shaped groove, and the clearance groove 222 is provided between the first clamping arm 21 and the soft pad 221. When the pivot angle between the first clamping arm 21 and the second clamping arm 22 is 60°, the soft pad 221 is directly opposite to the end of the earphone body 1. By providing the clearance groove 222, the situation of pinching the ear tissue by a sharp angle upon wearing can be effectively avoided. The soft pad 221 can increase the friction force with the ear upon wearing, to prevent the earphone from falling off. At the same time, the soft elastic material used can also improve the wearing experience, with softer clamping parts.

The adjusting member 23 comprises a coil spring 231 and a pin shaft 232. The pin shaft 232 is inserted into the coil spring 231, and both ends of the pin shaft 232 extend out of the coil spring 231. The end of the first clamping arm 21 is provided with a boss 214, and the boss 214 is provided with a coil spring cavity 2141. The second clamping arm 22 is provided with a groove 223, and the groove walls on both sides of the groove 223 are provided with pin shaft holes. The boss 214 is inserted into the groove 223, and the coil spring 231 is installed in the coil spring cavity 2141. The two ends of the pin shaft 232 are inserted into the corresponding pin shaft holes respectively, and the two ends of the pin shaft 232 are respectively connected to end caps 233 to achieve arbitrary positioning of the pivot angle between the first clamping arm 21 and the second clamping arm 22. Of course, the boss can also be provided at an end of the second clamping arm 22, and the boss is provided with a coil spring cavity, and the first clamping arm 21 is provided with a groove, and the groove walls on both sides of the groove are provided with pin shaft holes, and the boss is adapted to be inserted in the groove, and the coil spring 231 is adapted to be installed in the coil spring cavity, and the two ends of the pin shaft 232 are respectively inserted in the corresponding pin shaft holes to achieve arbitrary positioning of the pivot angle between the first clamping arm 21 and the second clamping arm 22. By configuring the scroll structure, the pivot angle between the earphone body 1 and the clamping assembly 2 can be arbitrarily positioned, and the earphones are not easy to fall off when consumers wear them, and they are convenient and comfortable to use.

This structure provides a certain holding force when rotated to any position. People with thicker ears may choose a larger angle, and people with thinner ears may choose a smaller angle. It has strong wearing compatibility and can be compatible with different ear sizes. The shaft torque is set between 2.0 N*cm-5.0 N*cm. This range ensures a secure and comfortable fit, smooth operation, and a positive user experience.

It should be pointed out that the specific structure of the adjusting member 23 is described in accordance with the drawings in the specification. In actual use, any structure and device that can achieve arbitrary positioning of the pivot angle between the first clamping arm 21 and the second clamping arm 22 may be used. This is only for better illustrating the present application and should not constitute a limitation to the present application.

Further, the second clamping arm 22 comprises a first arm body 224 and a second arm body 225. The first arm body 224 has a hard structure, and the first arm body 224 serves as the skeleton structure of the second clamping arm 22. The groove 223 is arranged on the first arm body 224. One or more fixing columns 2241, one or more fixing holes 2242, and a ridge 2243 are also arranged on one side of the first arm body 224. One or more fixing holes, one or more fixing columns, and a receiving groove corresponding thereto are arranged on one side of the second arm body 225, so that the second arm body 225 can be installed onto the first arm body 224. By configuring the second arm body with a soft elastic material, when the clamping assembly 2 is clamped onto the auricle, the clamping assembly 2 can better fit onto the auricle due to the large deformability of the soft elastic material. At the same time, since the soft elastic material is soft, it is more comfortable to wear. The soft elastic material includes but is not limited to silicone, synthetic rubber or polypropylene material, etc. The producer can select different soft elastic materials according to the actual situation in actual production, which will not be described one by one here, and all are within the protection scope of the present application.

In one embodiment, referring to FIG. 1 of the specification, the earphone body 1 is further provided with a sound outlet 15, which is arranged on a side of the earphone body 1 away from the clamping assembly 2, and the sound outlet 15 is at a preset distance from the end of the earphone body 1, so that when the earphone body 1 is worn onto the human ear, the sound outlet 15 is facing the ear canal.

Clip-on earphones use a clip-on structure to wear. They can be applied to in-ear earphones, semi-in-ear earphones, and open-ear earphones. These earphones are small in size, easy to carry, comfortable to wear, and reliably fixed. The sound output position of in-ear and semi-in-ear earphones is essentially fixed, as they are designed to block or fit into the ear canal. However, for open-ear earphones, the sound output position has a great impact on the sound quality of the earphones. The best sound output position is directly opposite the ear canal, and the closer the distance, the better the sound quality. However, because open-ear earphones must maintain their open characteristics, a certain distance must be left between the final sound output position and the ear canal to prevent the earphones from blocking the entrance of the ear canal and becoming semi-in-ear earphones. The position of the sound outlet 15 is at a preset distance from the end of the earphone body 1. When the end of the earphone body 1 is placed in the concha cavity, the bottom surface of the end of the earphone body 1 is attached to the tissue surface of the concha cavity. Therefore, the distance from the end of the earphone body 1 to the sound outlet 15 affects whether it is facing the ear canal. When the size of the earphone body 1 changes, the position of the sound outlet 15 must be adjusted according to the size of the earphone body 1 to ensure that the distance between the sound outlet 15 and the end of the earphone body 1 remains unchanged.

In this embodiment, the earphone body 1 and the clamping assembly 2 are connected to each other to jointly clamp the auricle, and the battery 111 and the speaker 112 are placed in the earphone body 1, so that weight is concentrated to the earphone body 1. In the wearing state, the earphone head is placed inside the concha cavity, and the side of the concha cavity supports the earphone head, which can disperse the weight of the earphone head to the greatest extent. The localized pressure is minimized, and there will be no sensation of oppression when wearing. By adjusting the clamping position of the clamping assembly 2 on the auricle, the earphone body 1 can be set above the human concha, and the earphone body 1 does not need to block the ear canal, thus reducing the possibility of damage to the wearer's eardrum and is more comfortable. Once put on, the sound outlet is directly opposite the ear canal, and the sound quality is optimal.

In the above-mentioned embodiments, the descriptions of each embodiment have their own emphases, and for parts that are not described or recorded in detail in a certain embodiment, reference may be made to relevant descriptions of other embodiments.

It should be noted that the above embodiments can be freely combined as required. The above are only preferred embodiments of the present application, and it should be pointed out that for those of ordinary skill in the art, some improvements and modifications can also be made without departing from the principles of the present application. It should be regarded as being within the protection scope of the present application.

1. A clip-on earphone, characterized by comprising:
an earphone body having a first accommodating cavity, wherein a battery and a speaker are installed in the first accommodating cavity; and
a clamping assembly comprising a first clamping arm, a second clamping arm and an adjusting member, wherein a first end of the first clamping arm is connected to the earphone body, and a second end of the first clamping arm is connected to the second clamping arm via the adjusting member, and the adjusting member is adapted to adjust a pivot angle between the first clamping arm and the second clamping arm so that the earphone body can be worn onto a human ear.

2. The clip-on earphone according to claim 1, characterized in that:
the first clamping arm has a second accommodating cavity, wherein the second accommodating cavity is interconnected to the first accommodating cavity, and a circuit board and an accessory component are installed in the second accommodating cavity.

3. The clip-on earphone according to claim 2, characterized in that:
the first clamping arm comprises a first connecting section and a second connecting section fixedly connected at a preset angle, wherein an end of the first connecting section away from the second connecting section is in a fix connection to the earphone body at a preset angle, and an end of the second connecting section away from the first connecting section is connected to the second clamping arm via the adjusting member.

4. The clip-on earphone according to claim 3, characterized in that:
an end of the earphone body is at a preset length from a place of the fix connection between the first connecting section and the earphone body to form an ear hook portion having the preset length, and the ear hook portion is adapted to hook onto a side wall of a concha cavity, and the preset length is not less than 3 mm.

5. The clip-on earphone according to claim 4, characterized in that:
the second connecting section is arranged parallel to the earphone body, and a distance between the second connecting section and the earphone body is 4 mm-7 mm; and
a length of the second connecting section is 8 mm-13 mm; and
an end of the second connecting section close to the first connecting section is flush with the end of the earphone body.

6. The clip-on earphone according to claim 3, characterized in that:
the earphone body, the first connecting section, and the second connecting section are integrally formed into a housing, and the housing comprises a bottom shell and an upper cover, and the bottom shell and the upper cover are detachably connected.

7. The clip-on earphone according to claim 1, characterized in that:
the pivot angle between the first clamping arm and the second clamping arm has a range of 60°-180.

8. The clip-on earphone according to claim 7, characterized in that:
the second clamping arm is provided with a soft pad and a clearance groove, wherein the soft pad is provided at the end of the second clamping arm away from the first clamping arm, and the clearance groove is an arc-shaped groove, and the clearance groove is provided between the first clamping arm and the soft pad; and
when the pivot angle between the first clamping arm and the second clamping arm is 60°, the soft pad faces the end of the earphone body.

9. The clip-on earphone according to claim 1, characterized in that:
the adjusting member comprises a coil spring and a pin shaft, wherein the pin shaft is inserted into the coil spring and both ends of the pin shaft extend out of the coil spring; and
the second end of the first clamping arm is provided with a boss, wherein the boss is provided with a coil spring cavity, and the second clamping arm is provided with a groove, and groove walls on both sides of the groove are provided with pin shaft holes, and the boss is adapted to be inserted into the groove, and the coil spring is adapted to be installed in the coil spring cavity, and both ends of the pin shaft are respectively inserted in the corresponding pin shaft holes, so as to realize an arbitrary positioning of the pivot angle between the first clamping arm and the second clamping arm.

10. The clip-on earphone according to claim 1, characterized in that:
the earphone body is also provided with a sound outlet, which is arranged on a side of the earphone body away from the clamping assembly, and the sound outlet is at a preset distance from an end of the earphone body, so that when the earphone body is worn onto a human ear, the sound outlet faces an ear canal.

11. The clip-on earphone according to claim 7, characterized in that:
when the pivot angle between the first clamping arm and the second clamping arm is 60°, a distance between an end of the second clamping arm away from the first clamping arm and an end of the earphone body is no more than 3 mm.

12. The clip-on earphone according to claim 1, characterized in that:
the adjusting member comprises a coil spring and a pin shaft, wherein the pin shaft is inserted into the coil spring and both ends of the pin shaft extend out of the coil spring; and
a boss is provided at an end of the second clamping arm, wherein the boss is provided with a coil spring cavity, and a groove is provided on the first clamping arm, and pin shaft holes are provided on groove walls on both sides of the groove, and the boss is adapted to be inserted into the groove, and the coil spring is adapted to be installed in the coil spring cavity, and two ends of the pin shaft are respectively inserted into the corresponding pin shaft holes, so as to realize arbitrary positioning of the pivot angle between the first clamping arm and the second clamping arm.

13. The clip-on earphone according to claim 3, characterized in that:
a distance between the second connecting section and the earphone body and a length of the second connecting section constitute an accommodation space for ear tissue at an earphone clamping position.

14. The clip-on earphone according to claim 11, characterized in that:
the distance corresponds to a tissue thickness at a concha cavity.

15. The clip-on earphone according to claim 1, characterized in that:
the adjusting member is adapted to hold at a position and maintain a clamping force.

16. The clip-on earphone according to claim 9, characterized in that:
a shaft torque is set between 2.0 N*cm-5.0 N*cm.

17. The clip-on earphone according to claim 4, characterized in that:
after the earphone body is placed in the concha cavity, the ear hook portion is hooked onto the side wall of the concha cavity, so that the first clamping arm covers an antitragus, and the second clamping arm is clamped onto a helix to complete clip-on fixation onto the ear by a joint action of the earphone body and the clamping assembly.

18. The clip-on earphone according to claim 3, characterized in that:
peripheral sides of the earphone body, the first connecting section, and the second connecting section are all smooth surfaces.

19. The clip-on earphone according to claim 9, characterized in that:
the second clamping arm comprises a first arm body and a second arm body, wherein he first arm body has a hard structure, and the first arm body serves as a skeleton structure of the second clamping arm, and the groove is arranged on the first arm body.

20. The clip-on earphone according to claim 19, characterized in that:
one or more fixing columns, one or more fixing holes, and a ridge are arranged on one side of the first arm body, and one or more fixing holes, one or more fixing columns, and a receiving groove corresponding thereto are arranged on one side of the second arm body, so that the second arm body can be installed onto the first arm body.
